(19) United States
(12) Patent Application Publication
(10) Pub. No.: US 2007/0209893 A1
(43) Pub. Date: Sep. 13, 2007

(54) Vibration reduction system for mixers

(75) Inventor: Stephen Carlson, Shorewood, MN (US)

Correspondence Address: FAEGRE & BENSON LLP;PATENT DOCKETING, 2200 WELLS FARGO CENTER, 90 SOUTH SEVENTH STREET, MINNEAPOLIS, MN, 55402-3901, US

(73) Assignee: Red Devil Equipment Company, Plymouth, MN (US)

(21) Appl. No.: 11/370,123

(22) Filed: Mar. 7, 2006

(51) Int. Cl. F16F 7/10

(52) U.S. Cl. 188/379

(57) ABSTRACT

The present invention provides a system to reduce undesired motion of a mixing machine comprising a tuned spring and mass system having a natural frequency that is approximately or exactly equal to a natural frequency of the mixing machine. The tuned spring and mass system may be mounted to a stand, to the mixing machine enclosure, or to a mixing machine.

The present invention provides a system to reduce vibration or unwanted motion exhibited in a mixer. The system comprises a spring and mass structure that is tuned to the resonant frequency of a mixer and that is placed either in a stand supporting the mixer or in certain portions of the mixer.

### BACKGROUND

Conventional paint mixers have been designed for mixing paint using both revolving (or orbital), spinning motion with the paint container held at an angle during paint mixing operation. To mix a paint container faster, the speed of rotation can be increased. Also, other motions such as shaking the paint can in a vertical, direction using an elliptical motion has been used in conventional paint mixers.

When a liquid is mixed at a higher speed or velocity, unacceptable motion and vibration results in these mixing systems. For example, imbalance of the paint container in conventional paint mixers manifests itself in vibration of the mixer. Placing a mixing machine on a stand may also cause the stand to shake. This is not visually attractive and the movement can negatively affect the life of the stand and potentially reduce the life of the mixer.

Another problem is that a stand holding vibrating equipment such as a mixer can “walk” or move. The tendency for the feet to move in relation to the floor is dependent on the combined weight of the stand and the mixing machine(s) place on the stand and the aggressiveness of the mixing.

Walking and vibration are worsened as mixing becomes more aggressive. As speeds increase, forces increase and both functionally unacceptable walking and visually unattractive vibration increase.

These problems are also worsened when a stand is tall, such as occurs when two machines are stacked. The height of the stand is a moment arm that can allow the side force to tip a stand slightly and create both walking and side to side motion.

### SUMMARY OF THE INVENTION

The present invention provides a system that overcomes the vibration and walking problems by placing a tuned spring and mass either on the stand or attached to the mixer. This tuned spring and mass combination or system is designed or tuned to approach or match the natural frequency of the mixer. Since deflection and acceleration in a system of this type are 180 degrees out of phase, most of the energy that shakes the stand is directed into the tuned spring and mass system (or into the tuned mass) and the overall vibration of the stand is greatly reduced.

Embodiments of the invention include having the tuned spring and mass system is mounted to a stand holding the mixing machine, having the spring and mass system is mounted to an enclosure or enclosure frame of the mixing machine, or having the tuned spring and mass system mounted to the mixing machine.

The features of the present invention are presented in the following description when considered with the accompanying drawings. It is to be expressly understood that the drawings are for the purposes of illustration only and are not intended as a limitation of the invention that is set out in the claims.

### BRIEF DESCRIPTION OF THE DRAWINGS

FIG. 1 is a schematic side view of a stand fitted with a tuned spring and mass system.

FIG. 2 is an enlarged view of the tuned spring and mass system of FIG. 1.

FIG. 3 is a schematic view of a mixing machine enclosure fitted with a tuned spring and mass system.

FIG. 4 is a schematic view of a mixing machine fitted with a tuned spring and mass system.

FIG. 5 is a perspective view of one embodiment of a stand.

FIG. 6 is a side view of the stand of FIG. 5.

FIG. 7 is a front view of the stand of FIG. 5.

FIG. 8 is a top view of the stand of FIG. 5.

FIG. 9 is an enlarged view of a foot of the stand of FIG. 5.

FIG. 10 is an enlarged view of a portion of the tune spring and mass system of the stand of FIG. 5.

FIG. 11 is a perspective view of a lower shelve of the stand of FIG. 5.

FIG. 12 is a perspective view of an upper shelve of the stand of FIG. 5.

FIG. 13 is a perspective view of an isolator of the tuned spring and mass system of the stand of FIG. 5.

FIG. 14 is a side view of the isolator of FIG. 13 illustrating, in phantom, a mounting stud.

FIG. 15 is a top view of a mass plate of the tuned spring and mass system of the stand of FIG. 5.

FIG. 16 is a top view of a mass plate of the tuned spring and mass system of the stand of FIG. 5.

### DETAILED DESCRIPTION

The present invention is a very simple way to reduce vibration without bearings, gears, or other power transmitting elements.

The tuned spring and mass system of the present invention reduces undesired vibration and motion because:
1) It is an “active” member—the mass or weight is not fixed firmly in position.
2) The movement of the mass or weight provides the benefit of vibration reduction for the rest of the system.
3) The natural frequency of the spring and mass system is tuned to match or come close to the natural frequency of the mixing machine or mixer. Tuning is a process of balancing the spring constant and mass of the system to respond to the motion of the mixer. In general, more mass is needed to achieve this when a less stiff spring is used, while less mass is needed to achieve this when a stiffer spring is used. The natural frequency of the spring and mass is tuned by either increasing or decreasing the mass or increasing or decreasing the spring constant. It is considered tuned when the natural frequency of the spring and mass system matches or come close to the natural frequency of the mixing machine or mixer.
4) It does not require any power transmission components (gears, pulleys, etc.).
5) It is possible to tune the spring and mass system to optimize for different mixer speeds or revolutions per minute or RPMs.

The advantages of the tuned spring and mass system, in part, are:
1) Simplicity—no mechanical power transmission components required.
2) It allows a small mass or weight to have a large impact on vibration reduction and elimination of motion such as walking.
3) It allows the mixer to have a larger or faster forcing function and still operate in a manner that is visually acceptable.

In one embodiment, the “spring” is vibration isolator. The natural frequency may be modified or optimized by twisting or rotating the isolator to provide a torque to the isolator. The term “spring”, however, may refer to any material with a spring constant that allows tuning the natural frequency of the system. The adjustability of the system to optimally reduce vibration could also be implemented in a system with other types of springs.

The mass may be made of any material or combination of materials that is structurally sound and has sufficient weight.

In one embodiment, a tuned spring and mass system is mounted to a stand. Typically, a stand is simply a welded or bolted together structure that holds a mixer. It is typically constructed of steel. It may be constructed of tubular members or sheet metal. It may also be constructed of wood though this is typically an on-site solution.

The problems of prevent walking and reducing side-side motion are conventional addressed in a few different ways. The stand and the mixer can be made heavy enough that walking will not occur. The speed of mixing may be reduced with the negative effect of less effective mixing. The isolation system in the mixer may be modified to reduce the force transmitted to the feet of the mixer or stand. The stand can also be bolted to the floor. The feet of the stand can be modified to provide an isolation function.

The vibration of the stand is significantly reduce when the tuned spring and mass system is added. Also, the tendency for the stand to walk due to the vibration was eliminated.

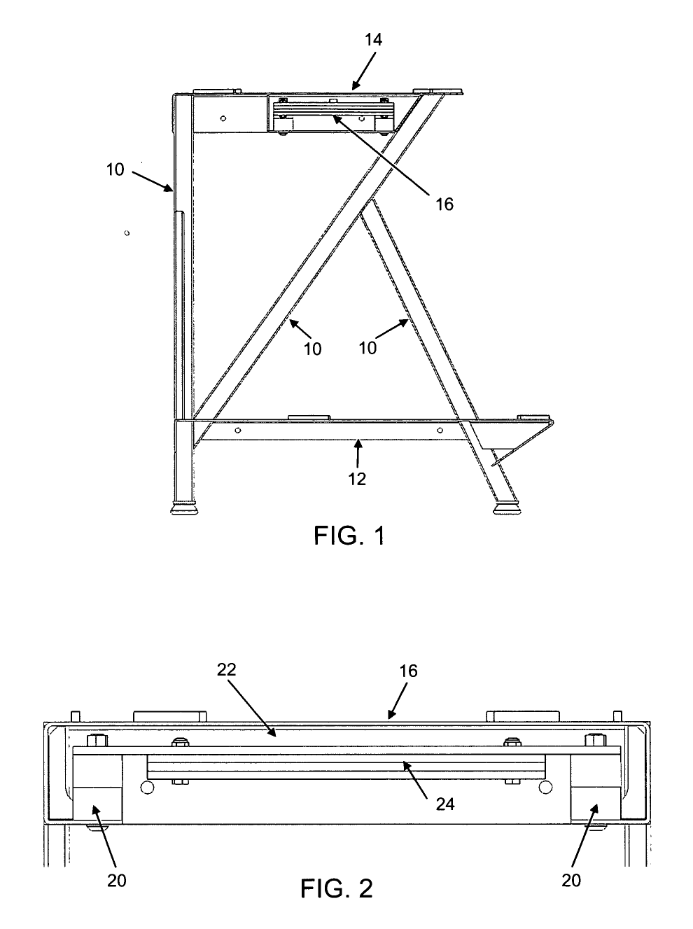

As illustrated in FIG. 1, a suitable stand includes supported legs 10 and both lower and upper shelves 12 and 14, respectively. In this embodiment, the upper shelve is intended to support a mixer and is fitted with a tuned spring and mass system 16. Although two shelves are illustrated only a single shelf could be used to hold the mixer.

FIG. 2 illustrates the tuned spring and mass system 16 that includes one or more springs 20 that are connected to the stand 10, a plate 22 connected to the springs 20 and one or more weights 24 that are connected to the plate. The plate and weights are free to move as vibration or motion caused by the mixer is transmitted from the stand to the springs and then to the plate. The movement of the plate and weights coupled solely to the springs reduces the undesired vibration and movement of the stand.

In another embodiment, a tuned spring and mass system it mounted to a mixer enclosure or the mixer itself.

Typically, a rotating mass or counterweight that is a part of the mixer is driven using gears or by being fixed opposite the mass being moved by the mixer. This may or may not provide sufficient vibration reduction.

Also, the whole weight of the frame, motor and rotating member is often mounted on isolators to reduce vibration.

Sometimes, a weight is also suspended by several springs or isolators between the base or enclosure of a mixer and the mixing portion of the mixer to dampen vibration. If a middle mass is used between the mixing portion of a mixer and the base or enclosure, the mixing portion passes energy to the middle mass which will have a lesser vibration than the mixing mechanism but more than the enclosure/base. In another embodiment of the present invention, the tuned spring and mass system may be added to the mixing portion of the mixer alone. The mass is not constrained between the mixing portion and the base therefore the mass can move or vibrate much more than a constrained middle mass and get out more energy.

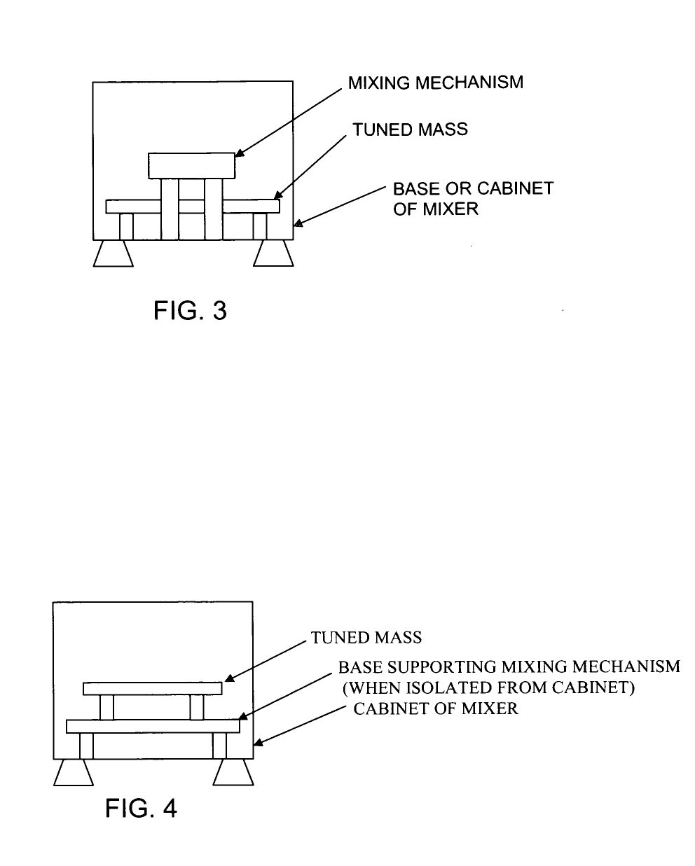

As illustrated in FIGS. 3 and 4, a tuned spring and mass system may be placed either on the enclosure of base of the mixer, illustrated in FIG. 3, or mounted internally to the mixer as illustrated in FIG. 4. It is understood that the tuned spring and mass system may be placed horizontally, as illustrated, or alternatively may be placed on a vertical surface.

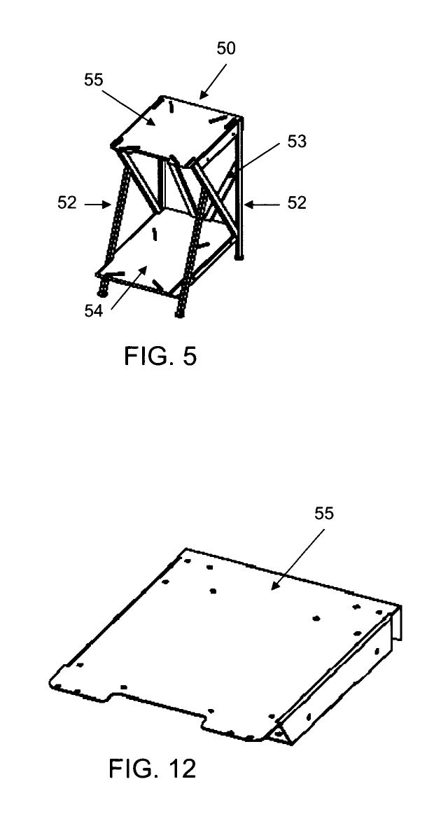

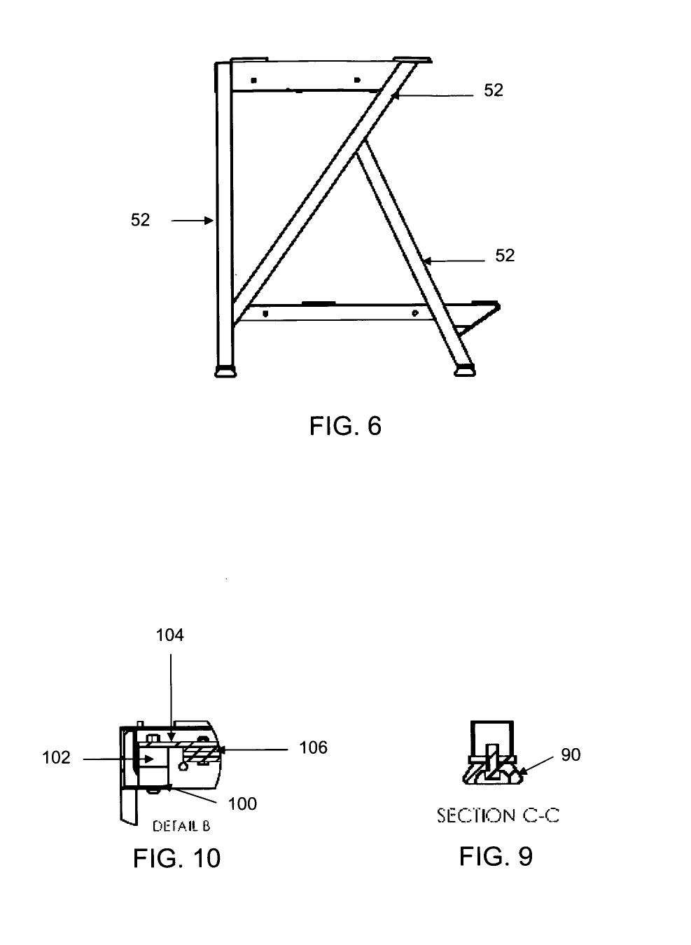

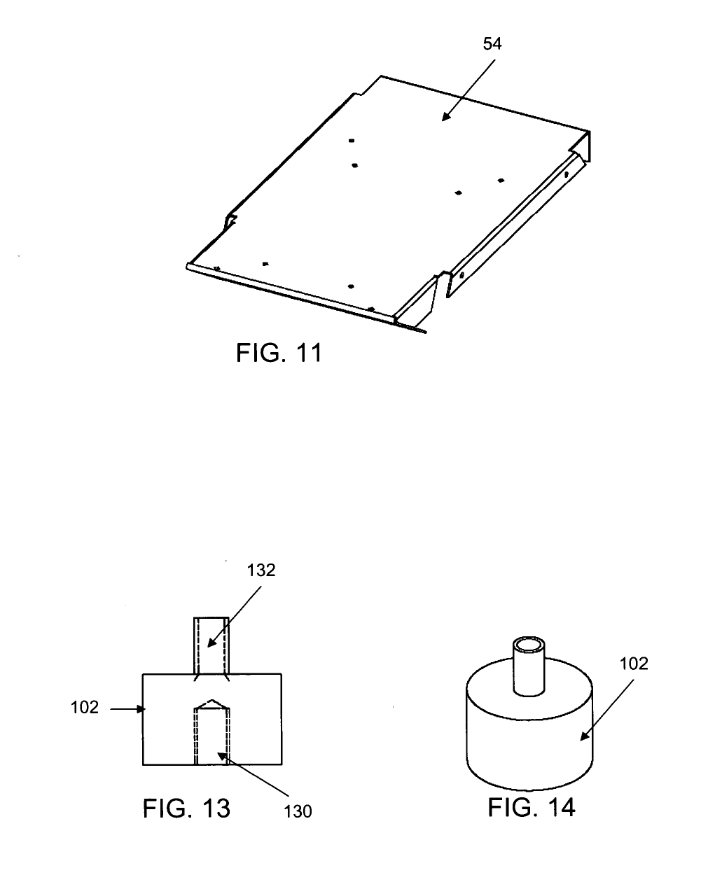

In still another embodiment, the invention is a stand fitted with a tuned spring and mass system illustrated in FIGS. 5-16. The stand in FIG. 5 includes steel rectangular tube supporting legs and braces as well as lower and upper steel shelves. Other types of metal and tubing shapes would be suitable materials. The supporting legs are welded together to form a “K” shaped configuration that is illustrated in FIG. 6. The steel tube braces are welded to the back of the stand in s “V” shaped configuration that is illustrated in FIG. 7. This figure further illustrates a tuned spring and mass system that is fitted underneath the upper shelf. In this embodiment, the lower shelf is longer, from the front to the back of the stand, than the upper shelf although both shelves are the same width as apparent in FIG. 8. Alternative shapes and sizes of the shelves would also be suitable. The edges of the shelves are bent or folded for attached to the supporting legs and braces and may be attached to these structures using known fasteners such as welds, rivets, bolts or screws. The configuration of the folds or bends for this embodiment are illustrated in FIG. 11 for the lower shelf and in FIG. 12 for the upper shelf. The bottoms of the supporting legs include isolator feet that are illustrated in FIG. 9. These isolator feet are made of rubber or other elastomeric materials and are attached to the supporting legs using any suitable fastener such as rivets, bolts or screws. A suitable rubber isolator foot has a 60 durometer hardness.

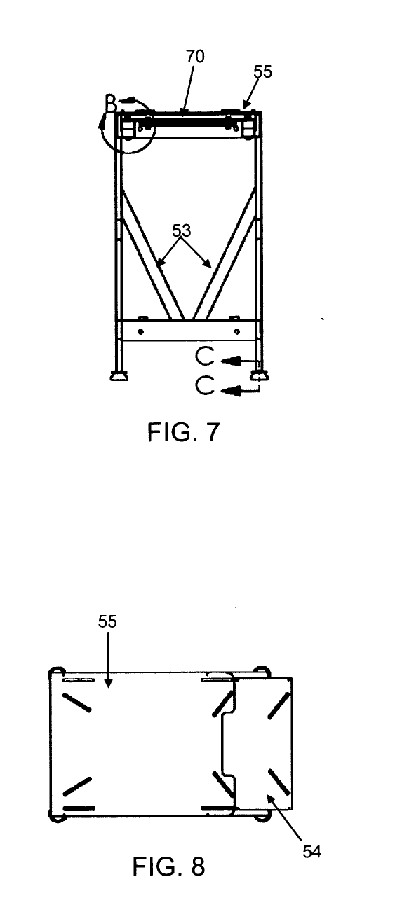

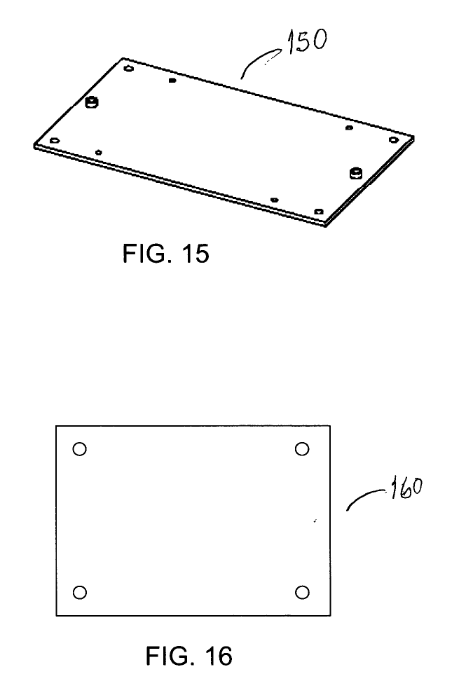

FIG. 7 illustrates that location of the tuned spring and mass system beneath the upper shelf. In this embodiment the system is attached to folded or bent brackets that are part of the upper shelf that are illustrated in detail in FIG. 10. The tuned spring and mass system of this embodiment includes three principle components, a group of rubber or elastomeric springs, a plate connected to the springs and group of weights connected to the plate. The lower portion of the springs are connected to the brackets on the lower shelf. One spring is placed near each corner of the upper shelf. A suitable spring is a cylindrical rubber isolator having a 30 durometer hardness. As illustrated in FIGS. 13 and 14, the rubber isolator includes internal structure for mounting the isolator to the upper shelf as well as external structure for mounting the plate to isolators. FIG. 15 illustrates a mounting plate 150 that is configured to connect to the isolators at each of the four corners plate and to connect to a group of weights. A suitable weight 160 is illustrated in FIG. 16. In this embodiment, the plate 150 and attached 160 weights are able to free to move within the constraints provided by the four isolators. Although the plate and weights are generally rectangular in shape, others shapes and configurations would be suitable.

This invention is not to be taken as limited to all of the details thereof as modifications and variations thereof may be made without departing from the spirit or scope of the invention

1. A system to eliminate undesired motion and walking of a mixing machine comprising a tuned spring and mass system.

2. The system of claim 1 wherein the tuned spring and mass system is mounted to a stand holding the mixing machine.

3. The system of claim 1 wherein the tuned spring and mass system is mounted to an enclosure or enclosure frame of the mixing machine.

4. The system of claim 1 wherein the tuned spring and mass system is mounted to the mixing machine.

5. A system to reduce undesired motion of a mixing machine comprising a tuned spring and mass system having a natural frequency that is approximately or exactly equal to a natural frequency of the mixing machine.

6. The system of claim 5 wherein the tuned spring and mass system is mounted to a stand holding the mixing machine.

7. The system of claim 5 wherein the tuned spring and mass system is mounted on the enclosure or enclosure frame of the mixing machine.

8. The system of claim 5 wherein the tuned spring and mass system is mounted to the mixing machine.

9. The system of claim 5 wherein the tuned spring and mass system is tuned for different speeds.

10. A stand to support a mixing machine comprising
a) supporting legs;
b) an upper shelf; and
c) tuned spring and mass system.

11. The stand of claim 10 wherein the tuned spring and mass system comprises a group of isolators connected to the upper shelf, and a weight connected to the group of isolators.

12. The stand of claim 11 wherein the group of isolators are connected by a plate and the weight is connected to the plate.

13. The stand of claim 10 further comprising a lower shelf.

14. The stand of claim 10 further comprising one or more braces.

15. The stand of claim 10 further comprising rubber or elastomeric feet connected to the supporting legs.

16. The stand of claim 10 wherein the group of isolators are rubber or elastomeric springs.

17. The stand of claim 16 wherein the isolators have a 30 durometer hardness.

18. The stand of claim 10 wherein the tuned spring and mass system has a natural frequency that is approximately or exactly equal to a natural frequency of the mixing machine.
